(19) United States
(12) Patent Application Publication
(10) Pub. No.: US 2025/0182111 A1
(43) Pub. Date: Jun. 5, 2025

(54) HARDWARE SECURE ENCLAVE AND BLOCKCHAIN BASED SYSTEM AND METHOD FOR SECURING AND MONETISING ACCESS TO DATA

(71) Applicant: APPLIED BLOCKCHAIN LTD, London (GB)

(72) Inventor: Adi BEN-ARI, London (GB)

(21) Appl. No.: 19/044,199

(22) Filed: Feb. 3, 2025

Related U.S. Application Data
(63) Continuation of application No. PCT/IL2023/050771, filed on Jul. 24, 2023.
(60) Provisional application No. 63/395,105, filed on Aug. 4, 2022.

(51) Int. Cl. G06Q 20/40; G06Q 20/02; G06Q 20/38; H04L 9/32

(52) U.S. Cl. CPC G06Q 20/401; G06Q 20/02; G06Q 20/38215; G06Q 20/3825; H04L 9/3247

(57) ABSTRACT

The present invention relates to a system and method for monetizing access to data using a blockchain-based framework with hardware secure enclaves (HSEs). The system enables data owners to securely store and control access to their data while ensuring payment for access through blockchain smart contracts. The system comprises a hardware secure enclave configured to lock data off-chain, store it securely, and provide cryptographic proof of data properties to authorized parties. Data access is monetized through the submission of funds to a smart contract, with payment verified on-chain and processed by the enclave. The system utilizes unique enclave signatures to manage notifications and triggers related to data access requests. Furthermore, the system employs blockchain relayers to ensure timely communication and transaction verification. A universal attestation process is used to ensure the integrity of the enclave's code. This invention provides a secure, efficient, and scalable solution for monetizing data access, leveraging secure enclave technology and blockchain for transparent and tamper-resistant transactions.

### CROSS REFERENCE TO RELATED APPLICATIONS

This application is a Continuation of PCT Patent Application No. PCT/IL2023/050771 having International filing date of Jul. 24, 2023, which claims the benefit of priority of U.S. Provisional Patent Application No. 63/395,105, filed Aug. 4, 2022, the contents of which are all incorporated herein by reference in their entirety.

### FIELD OF THE INVENTION

The present invention relates to the field of internet security, more particularly to systems and methods for securely managing and monetizing data through the integration of hardware-based security mechanisms and distributed ledger technologies.

### BACKGROUND OF THE INVENTION

At present, the use of online services (Google, Facebook, Microsoft, Yahoo), surrenders the ownership of the user's personal data to the owner of the service when the user checks the tickbox agreeing to the terms and conditions of the service. The terms and conditions include a consent of the user transferring ownership of their personal data to the service, who may store and use the data.

An example of the reach and scope of Google's access to personal data is described in the 2014 statement by Google, as follows:

“Our automated systems analyze your content (including e-mails) to provide you personally relevant product features, such as customized search results, tailored advertising, and spam and malware detection. This analysis occurs as the content is sent, received, and when it is stored.”

By reading and scanning personal emails, analyzing and interpreting users calling on services such as google maps, android phones, play store, as well as harvesting data on the user's connections to other users, valuable and intimate details of the user and their contacts is gathered and traded to outside companies and advertisers so that they can send the user targeted adverts. Outside companies bid to the social network companies (google, Facebook etc.) for on-screen real estate to win the right to display their own advertisements, usually based on keywords.

As a general rule, when a user signs up for free new account on a social network or other website, user behaviour on the site and data being collected becomes the asset of value to the social network company. Although Google and Facebook claim that user data is never shared directly with third parties, the system is managed through internal algorithms to match advertisers with relevant users.

There are some solutions enabling users to partially manage their own data. For example, virtual private networks (VPNs) create a secure tunnel through which encrypted data is sent from the home or office network to the open internet. Digital technology companies such as Google and Facebook can still track user activity while the user is logged in, but have difficulty identifying user locations.

“A Blockchain Platform for User Data Sharing ensuring user control and Incentives” Shrestha et al. (Front, Blockchain, 22 Oct. 2020 Sec. Blockchain for Good, https://doi.org/10.3389/fbloc. 2020.497985) reports a system based on user-controlled privacy and data-sharing policies encoded in smart contracts supporting building up incentives for users to share their profile data, in terms of rewards. Users become owners of their data and can decide how their data is collected and used, as well as shared. To share user profile data in a distributed fashion, streams from the MultiChain are used. We have combined blockchains and off-blockchain repository to create a data sharing and management model focused on security and privacy.

Additionally, see the following: A. Kiran, S. Dharanikota and A. Basava, “Blockchain based Data Access Control using Smart Contracts,” TENCON 2019-2019 IEEE Region 10 Conference (TENCON), 2019, pp. 2335-2339, doi: 10.1109/TENCON.2019.8929451.

Abstract: The keystone of information security has been access control. Very often, User data is misused and users are oblivious to the use of their data by unauthorized parties. Current strategies to provide storage for confidential data and subsequent authentication involve relying on a trusted third party for the same, which could be victims of Denial of Service (DOS) attacks or technical failures. This paper examines a strategy where the underlying framework for providing Access Control is the blockchain, hence decentralizing the mechanism of providing access control. Further in this paper, we demonstrate and model the User Data access on the Ethereum framework. Personal Information of the user by a website or an application is retrieved on a need-to-know basis from the off-blockchain, as determined by the user, the true owner of the data. Personal data is highly protected and the different permissions to different websites or applications are determined by the Smart Contract (see URL: https://ieeexplore.ieee.org/stamp/stamp.jsp?tp=&arnumber=8929451&isnumber=8929228).

This following work was supported in part by the Oxford-Hainan Blockchain Research Institute, in part by the National Natural Science Foundation of China under Grant 61472074 and Grant U1708262, in part by the Fundamental Research Funds for the Central Universities under Grant N172304023, and in part by the National Key Research and Development Program of China under Grant 2018YFB0803400 and Grant 2019YFB2101601: When Blockchain Meets SGX: An Overview, Challenges, and Open Issues ZIJIAN BAO¹, QINGHAO WANG^{1,2}, WENBO SHI², LEI WANG³, HONG LEI¹, AND BANGDAO CHEN¹; ¹Oxford-Hainan Blockchain Research Institute, Chengmai 571924, China; ²Department of Computer Science and Engineering, Northeastern University, Shenyang 110001, China; ³Department of Computer Science and Engineering, Shanghai Jiao Tong University, Shanghai 200240, China Corresponding author: Hong Lei (leihong@oxhainan.org); ABSTRACT: As a decentralized, public, and digital ledger technology in Peer-to-Peer network, blockchain has received much attention from various fields, including finance, healthcare, supply chain, etc. However, some challenges (e.g., scalability, privacy, and security issues) severely affects the wide adoption of blockchain technology. Recently, Intel software guard extensions (SGX), as new trusted computing technologies, have provided a new solution to the above challenges in the blockchain area. Although many studies have focused on using SGX technology to enhance their schemes in the blockchain areas, no comprehensive survey has systematically analyzed and delineated these studies. This article is the first to systematically discuss the application status of SGX in the blockchain area. In this article, we study the scheme designs, advantages, and disadvantages of the existing works using a six-layer hierarchical structure of the blockchain. We also summarize the functions of SGX and formally analyze the advantages and disadvantages of SGX. Finally, we review the remaining challenges and present a list of possible directions for future research.

### BLOCKCHAIN ENABLED SMARTPHONES

A prior art solution to enable the user to maintain control over their data is by using so called block-chain enabled smartphones.

An example is the Finney U1 running on the Sirin OS with its Security Suite and decentralized apps. The smartphone features an embedded cold storage crypto wallet token conversion center and embedded decentralized apps (see https://innovationatwork.ieee.org/blockchain-smartphones-going-mobile/and https://decrypt.co/10794/best-blockchain-phones).

In U.S. Pat. No. 10,123,202B1 (Verizon) System and method for virtual SIM card, Subscriber identity module (SIM) cards typically are individually formatted with a service provider's authentication credentials, an International Mobile Subscriber Identity (IMSI), an integrated circuit card identifier (ICCID), etc. in secured vendor factories as part of the manufacturing process. For devices that are branded for a specific wireless service provider, the SIM card is usually pre-inserted into a device at the original equipment manufacturer (OEM) facility or it may also be inserted at time of sale.

A major drawback of blockchain smartphones, however, is that data accumulates on the smartphone, and once the data is shared with someone else, it is out of the control of the owner.

Therefore, there still remains a long felt and unmet need to secure user data, and also to restore ownership of the data to the user, and enable the data to be monetized or traded by the user.

### SUMMARY OF THE INVENTION

The present invention relates to a server-based system and method for securely managing and monetizing access to data through the integration of a hardware secure enclave and blockchain technology. The system enables data owners to retain control over their private data while allowing secure, transparent transactions for data access. By leveraging a hardware secure enclave such as Intel's Software Guard Extensions (SGX) and utilizing blockchain-based smart contracts, the invention ensures that data can only be accessed by authorized parties after verifying payment, thus protecting data privacy and enabling the monetization of personal data. This invention aims to address the challenges of data privacy, security, and control, while providing an efficient, scalable solution for data access and value exchange in a decentralized environment. The system further incorporates blockchain relayer modules and cryptographic attestation to ensure the integrity and security of the data access process.

It is an object of the present invention to provide a server-based blockchained system for monetizing access to data, comprising:
a. at least one computer-readable memory;
b. at least one computer-readable medium (CRM);
c. at least one processor;
d. a hardware secure enclave (HSE) implemented within said at least one processor; said HSE configured to provide a signed blockchain account for receipt of payment for a data storage module within said HSE;
e. a data monetizing application implemented within said HSE;
f. an enclave API for rendering said data or cryptographic proof of properties of said data, inaccessible except through said enclave API having a function for retrieving said data or cryptographic proof of properties of the data; and
g. machine-readable instructions stored on said at least one CRM for execution by said at least one processor via said at least one memory, configured to:
   i. submit funds on-chain into a smart contract with stated intent to access specific data via an on-chain data policy;
   ii. lock data off-chain sent by a data owner into said HSE by sending encrypted data utilizing Hypertext Transfer Protocol Secure (HTTPS) to said HSE, or enable said HSE to securely and privately retrieve owner data from a third-party application programming interface (API) off-chain by making an HTTPS request to said third-party API;
   iii. provide said smart contract with a unique enclave signature enabling notifications based on said unique enclave signature to be accepted;
   iv. provide said data owner with a signed blockchain account;
   V. store said data off-chain in said HSE;
   vi. call a triggering function off-chain, by a data accessor, from said HSE; said triggering function including a signed blockchain account representing the party accessing said data;
   vii. notify, by said triggering function, said smart contract on-chain when a data access request is received;
   viii. submit, by said HSE, a universal attestation request to a processor manufacturer attestation module; said universal attestation request comprising the same HSE code attested for all data access requests;
   ix. receive, by said smart contract, on-chain verification that said HSE is to be accessed by said blockchain account holder and said smart contract charges for access by transferring tokens from said data accessor to said data owner; said payment may be taken in one step, escrowed by said smart contract;
   x. notify, by a blockchain relayer, said HSE on receipt of payment;
   xi. verify, by said data monetizing application, said transaction by means of a light client or state proofs; and xii. provide requested data or cryptographic proof of properties of said data to said data accessor.

It is a further object of the present invention to provide the abovementioned system wherein said system comprises a blockchain relayer module for notifying said HSE that payment of said charge was made.

It is a further object of the present invention to provide the abovementioned system wherein said enclave application is programmed to verify the fee payment transfer transaction using a light client, state proofs, before enabling requested data (or cryptographic proof of properties of the data), to be retrieved by said data accessor.

It is an object of the present invention to disclose a method of locking and monetizing access to data by steps of:
a. submitting funds on-chain into a smart contract with stated intent to access specific data via an on-chain data policy;
b. locking data off-chain sent by a data owner into a hardware secure enclave (HSE) by sending encrypted data utilizing Hypertext Transfer Protocol Secure (HTTPS) to said HSE, or enabling said HSE to securely and privately retrieve owner data from a third-party application programming interface (API) off-chain by making an HTTPS request to said third-party API;
c. providing said smart contract with a unique enclave signature enabling notifications based on said unique enclave signature to be accepted;
d. providing said data owner with a signed blockchain account;
e. storing said data off-chain in said HSE;
f. calling a triggering function off-chain, by a data accessor, from said HSE; said triggering function including a signed blockchain account representing the party accessing said data;
g. notifying, by said triggering function, said smart contract on-chain when a data access request is received;
h. submitting, by said HSE, a universal attestation request to a processor manufacturer attestation module; said universal attestation request comprising the same HSE code attested for all data access requests;
i. receiving, by said smart contract, on-chain verification that said HSE is to be accessed by said blockchain account holder and said smart contract charges for access by transferring tokens from said accessing account to said data owner;
j. notifying, by a blockchain relayer, said HSE on receipt of payment;
k. verifying, by an HSE application, said transaction by means of a light client or state proofs; and
l. providing requested data or cryptographic proof of properties of said data to said data accessor.

It is a further object of the present invention to disclose the abovementioned method comprising further steps of sealing said data by encrypting said data using said enclave key and storing said encrypted data in a file system, such that only said HSE, or an enclave with said key can decrypt said sealed data.

It is a further object of the present invention to disclose the abovementioned method comprising further steps of said data owner digitally signing and enabling a secure and encrypted HTTPS call directly from said HSE to a third-party service to retrieve said data on behalf of said data owner.

It is a further object of the present invention to disclose the abovementioned method comprising further steps to ensure said data will not be lost in case of a failed Software Guard Extensions (SGX) central processing unit (CPU), said method enabling transfer of said enclave key between a group of HSEs, such that if one CPU fails, the other CPUs can recover said data and enable continued operation of said system configured such that said enclave key cannot be extracted from said HSEs.

It is a further object of the present invention to disclose the abovementioned method wherein said blockchain is a forked blockchain.

It is a further object of the present invention to disclose the abovementioned method wherein there are a plurality of blockchain relayers.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 discloses methods of the present invention, in accordance with an embodiment of the present disclosure.

FIG. 2 discloses basic elements of the present invention, in accordance with an embodiment of the present disclosure.

### DETAILED DESCRIPTION OF THE PREFERRED EMBODIMENTS

For the purposes of promoting an understanding of the principles of the invention, reference will now be made to the embodiments illustrated in the figures and specific language will be used to describe the same. While examples and features of disclosed principles are described herein, modifications, adaptations, and other implementations are possible without limitation of the scope of the disclosed embodiments. Any further applications of the principles as described herein are contemplated as would normally occur to one skilled in the art.

This disclosure employs open-ended permissive language, indicating for example, that some embodiments “may” employ, involve, or include specific features. The use of the term “may”, and other open-ended terminology is intended to indicate that although not every embodiment may employ the specific disclosed feature, at least one embodiment employs the specific disclosed feature.

In the following description, it is to be understood that the present disclosure may be practiced without one or more of the following details. Reference will now be made in detail to non-limiting examples of this disclosure, examples of which are illustrated in the accompanying figures. The examples are described below by referring to the figures, wherein like reference numerals refer to like elements. When similar reference numerals are shown, corresponding description(s) are not repeated, and the interested reader is referred to the previously discussed figure(s) for a description of the like element(s).

Various embodiments are described herein with reference to a system(s) and method(s). It is intended that the disclosure of one is a disclosure of all. For example, it is to be understood that disclosure of a system described herein also constitutes a disclosure of the method implemented by the system, via, for example, one or more processors. It is to be understood that this form of disclosure is for ease of discussion only, and one or more aspects of one embodiment herein may be combined with one or more aspects of other embodiments herein, within the intended scope of this disclosure.

The following description is provided, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide a method and system for server-based system and method enabling users to control and monetize access to their own data when using social media.

### Definitions

The term trusted execution environment (TEE) is herein defined as secure area of a main processor 280. It guarantees code and data loaded inside to be protected with respect to confidentiality and integrity, Data integrity prevents unauthorized entities from altering data when any entity outside the TEE processes data, Code integrity guarantees that the code in the TEE cannot be replaced or modified by unauthorized entities, which may also be the computer owner itself as in certain Digital Rights Management (DRM) schemes described in SGX. This is done by implementing unique, immutable, and confidential architectural security such as Intel® Software Guard Extensions (Intel®) SGX) which offers hardware-based memory encryption that isolates specific application code and data in memory. Intel® SGX allows user-level code to allocate private regions of memory, called enclaves, which are designed to be protected from processes running at higher privilege levels

The term “Secure Enclave” or “Hardware Secure Enclave” is herein described with particular relevance to the present invention.

A secure enclave 250 provides CPU hardware-level isolation and memory encryption on every server 210, by isolating application code and data 240 from anyone with privileges, and encrypting its memory. With additional software, secure enclaves enable the encryption of both storage and network data for simple full stack security. Secure enclave hardware support is built into new CPUs for servers from Intel and AMD.

Enclaves are solutions which are built into the CPU and provide hardware security. Using a dedicated set of instruction codes, enclaves are isolated regions of memory which are protected from processes running at any privilege level, including the operating system.

The term and product “Intel Software Guard Extensions (SGX)” is herein described with particular relevance to the present invention.

Intel Software Guard Extensions (SGX) is a set of security-related instruction codes that are built into some Intel central processing units (CPUs). They allow user-level and operating system code to define private regions of memory, called enclaves, whose contents is inaccessible from the outside.[1][2] SGX is designed to be useful for implementing secure remote computation, secure web browsing, and digital rights management (DRM). Other applications include concealment of proprietary algorithms and of encryption keys. SGX involves encryption by the CPU of a portion of memory (the enclave).

SGX is designed to be useful for implementing secure remote computation, secure web browsing, and digital rights management (DRM).[3] Other applications include concealment of proprietary algorithms and of encryption keys.[4]

SGX involves encryption by the CPU of a portion of memory (the enclave). Data and code originating in the enclave are decrypted on the fly within the CPU,[4] protecting them from being examined or read by other code,[4] including code running at higher privilege levels such the operating system and any underlying hypervisors.[1][4][2] While this can mitigate many kinds of attacks

The term “transparency” used herein refers to the fact that blockchains are entirely open-source software. This means that anyone and everyone can view its code. Auditors are given the ability to review whatever data is on the blockchain.

The term “attestation” is used herein to define a mechanism for a remote user to verify that the application runs on a real hardware in an up-to-date Trusted Execution Environment (TEE) with the expected initial state that includes a hash of the source code of the application running in the enclave.

There are two types of attestation: Local Attestation and Remote Attestation. Local attestation is used when two TEEs run on the same physical machine and remote attestation is used when a user attests a TEE running on a remote physical machine.

The term “hash” or hashing is the process of transforming any given key or a string of characters into another value. This is usually represented by a shorter, fixed-length value or key that represents and makes it easier to find or employ the original string. Hashing in blockchain refers to the process of having an input item of whatever length reflecting an output item of a fixed length. A source code hash is the hash of a text listing of commands to be compiled or assembled into an executable computer program.

The term “Light clients” is defined herein:

Light clients or light nodes help users access and interact with a blockchain in a secure and decentralized manner without having to sync the full blockchain. A light client or light node is a piece of software that connects to full nodes to interact with the blockchain. Unlike their full node counterparts, light nodes do not need to run 24/7 or read and write a lot of information on the blockchain. Light clients do not interact directly with the blockchain; they instead use full nodes as intermediaries. Light clients rely on full nodes for many operations, from requesting the latest headers to asking for the balance of an account.

It is a purpose of the invention to disclose a user-centric server-based solution to enable a user to not only legally own their data, but to functionally control who has access to the data and to obtain rewards and incentives by allowing other entities access to the user owned data. In the present invention, protection of the data is provided through a hardware secure enclave, and monetization is achieved through the blockchain. It is acknowledged that the blockchain is a system or network where data is distributed. Because the data goes through several nodes on the blockchain the data is not secure. The blockchain is a distributed ledger of transactions cryptographically chained to each other, and any transaction recorded in the ledger is relatively immutable. The immutability is guaranteed by the many different validations which all must agree when a transaction occurs. Thus, the history of transactional events on the blockchain is securely protected. Another important property of the blockchain is that it is transparent, that is to say, the data on the block chain is available to everyone all the time, and all transactions are visible to all. Transparency of the blockchain guarantees that deleting or editing an item will create a record of when it was deleted and by whom across the entire network. It therefore follows that access to the data is unprotected.

Using blockchain smartphone wallet solutions enables the data to reside on the device and the owner may then decide who may share the data. A major drawback of using these solutions is that data accumulates on the smartphone, and once the data is shared with someone else, it is out of the control of the owner. Another disadvantage is that the data is mastered on the user's device, and if the device is damaged, destroyed, stolen or misplaced, then the original data help in the secure wallet will be lost. A further disadvantage is that a user's data may accumulate over time to the point where it is not practical to master and store only on their mobile device. Another disadvantage is that if the user did want to permit certain and specific types of aggregate analysis of their data alongside data of others, this could not be achieved on their mobile device, and the data would have to be shared, at which point they would usually lose control of their data.

The present invention is a server-based solution ensuring that anyone who accesses data will be forced to pay the data owner. This is achieved by providing a cryptographic “lock” between the activity of payment for the data using blockchain tokens, with the process providing access to the data in the secure enclave.

The method of the present invention enables private data to flow into a hardware (HW) enclave such as the Intel Software Guard Extensions (SGX) in Intel central processing units (CPUs).

Crucial properties of the HW enclave are privacy and the ability of the user's unique code to be attested by the manufacturer such as Intel. Any code that has been attested to by the manufacturer guarantees that the code was run in the enclave. If code in the enclave is changed, the attestation is no longer valid, and this can be detected by the user. The personal data is therefore safe. If a person or entity wants to access the data, the enclave code calls and notifies the blockchain that the data is being accessed. The data will only be given when the monetization event has occurred on the blockchain managing the transaction.

The core of the present invention depends on the use of a Hardware enclave 250.

An SGX component (or similar hardware secure enclave with third party attestation service) is used to lock the data.

The SGX will only release the data (or cryptographic proof of properties of the data) after there is proof from the blockchain that the data was paid for. This blockchain event will be validated inside the enclave through implementation of a light client.

An application 251 is installed inside the enclave including functions enabling a user to store their data and a third party to retrieve all or part of the data, or cryptographic proofs regarding properties of the data.

### Requesting Enclave and Code Attestation 260

A data monetization smart contract is created including the signature of a specific enclave (the enclave signature being backed by the manufacturer attestation of the enclave application source code hash).

Data owner sends data encrypted (HTTPS) to the enclave signed by their blockchain account private key (wallet), having verified the enclave attestation and source code and determining that it is safe to do so.

The data may also be provided to the enclave by the data owner digitally signing and enabling a secure and encrypted HTTPS call directly from the hardware enclave to a third-party service to retrieve their data on their behalf.

In some embodiments of the invention, the user can either send their private data encrypted directly from their device to the enclave, or they may instruct the enclave to retrieve the data on their behalf from a third-party web service (e.g., open banking, utility provider, social media account etc.)

A data retriever submits pre-payment in the form of tokens into an escrow service in the blockchain smart contract.

Data is requested from the enclave by a data retriever calling a function of the enclave signed using a blockchain account private key (wallet) representing the party accessing the data, activating a function in the enclave application triggering a call from the enclave to the blockchain smart contract. This call is in the form of a blockchain transaction and notifies the contract that the data is to be accessed, providing proof signed by the enclave key, and the blockchain charges for the access by transferring tokens from the escrow provided by the data accessing account to the data holder. The escrow can be time (block) locked, such that if the data is not retrieved within a predefined period, the escrow funds are released back to the unsuccessful data retriever.

The relayer monitoring the blockchain smart contract transactions notifies the enclave that payment was made, and the enclave application verifies this transaction using a blockchain light client, state proofs etc., and, having established the payment for the data has been settled on the blockchain, enables the caller to retrieve the data.

The secure enclave of the system in the present disclosure refers to a specialized hardware-based execution environment designed to ensure that data and computations remain protected from unauthorized access, tampering, or alteration. Secure enclaves may include, but are not limited to, Intel's Software Guard Extensions (SGX), Intel's Trusted Execution Technology (TDX), as well as other types of secure enclave technology such as those offered by AMD, Nvidia, and others. These enclaves provide a secure area within a processor where code and data can be executed or stored in isolation from the rest of the system. This isolation is critical for maintaining the confidentiality and integrity of sensitive data and computations.

Furthermore, technologies like Intel TDX, which incorporates disk encryption alongside the enclave, offer an enhanced level of security by ensuring that both the data in memory and on disk remain protected. The combination of these technologies forms a robust and flexible foundation for ensuring secure data storage, access control, and processing, allowing for a range of use cases within blockchain-based data monetization systems.

In some embodiments, a provisioning service is implemented to ensure that the enclave, once attested, is properly registered and associated with a smart contract. When the enclave is provisioned, its identity and code are attested through an attestation process to verify that the enclave is running the expected software and is trustworthy. Once attested, the enclave's identity and code signature are registered in a smart contract, where they are stored securely on the blockchain. Before any information or data is passed from the enclave to trigger functions within the smart contract, the smart contract performs a verification step to ensure that it is communicating with the correct enclave that has been pre-registered and attested. This attestation mechanism helps mitigate the risk of interacting with a compromised or unauthorized enclave, as only enclaves that match the registered signature are allowed to trigger blockchain functions, providing an additional layer of security and trust within the system.

In further embodiments, to provide scalability and resilience in the face of failures or increased demand, the system employs a network of enclaves that can be interconnected, creating a trusted, distributed network of secure enclaves. This network ensures that data access and computations can be scaled horizontally by adding additional enclaves, which can each independently handle secure data storage, processing, and transactions. The network of enclaves establishes trusted connections between them, enabling the secure sharing of keys, authentication data, or other sensitive information needed to maintain the integrity of the system. In the event of enclave failure or overload, the system can seamlessly route requests to other available enclaves in the network, ensuring minimal disruption and enhancing resilience. Additionally, this decentralized approach enables the creation of a more robust system that can operate under varying levels of demand, making it suitable for large-scale deployment in diverse use cases.

In other embodiments, a light client is integrated within the enclave, ensuring that the enclave can independently interact with the blockchain without relying on external nodes. The light client, which is a lightweight version of the full blockchain client, is designed to communicate with the blockchain in a manner that minimizes resource usage while still maintaining the necessary functionality for verifying transactions and accessing data on-chain. By hosting the light client inside the enclave, the system ensures that the code running the client is also subject to the enclave's attestation process. This provides assurance that the light client's code is authentic, unaltered, and operating securely. Furthermore, the light client helps drive on-chain activity by allowing the enclave to verify blockchain transactions and submit relevant information to smart contracts in a trustless and verifiable manner. This integration of the light client into the enclave adds another layer of security and ensures that interactions with the blockchain are conducted under the protections of the secure enclave.

In some embodiments, the only component that resides outside of the secure enclave is the relayer, which is responsible for passing messages between the enclave and other system components or users. The relayer is not responsible for processing or storing sensitive data, and as such, it does not need to be housed within the enclave. Its primary function is to relay messages between the blockchain and the enclave, ensuring that information flows smoothly between the on-chain and off-chain components of the system. To enhance the robustness and security of the relayer, it can be decentralized to prevent censorship or tampering, ensuring that the relayer remains a passive intermediary that facilitates communication without being a potential point of failure or control. By maintaining a decentralized relayer, the system preserves the integrity of its message passing and ensures that access to the enclave is not subject to centralized control, further enhancing the overall trustworthiness and resilience of the platform.

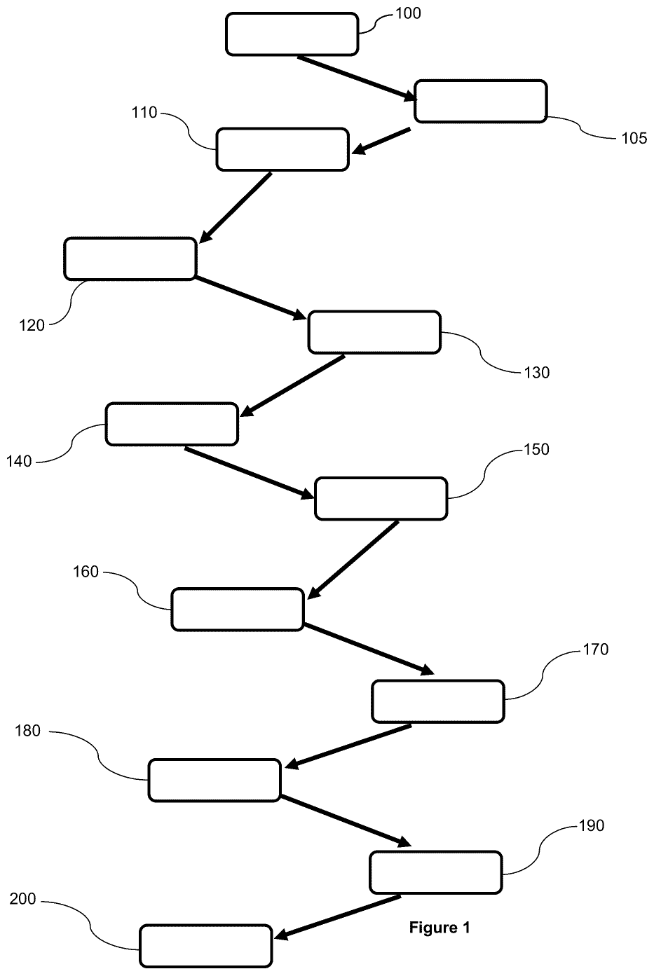

Herein is disclosed in FIG. 1 an aspect of the invention; a method of locking and monetizing access to data by steps of:
a. submitting 100 funds on-chain into a smart contract with stated intent to access specific data via an on-chain data policy;
b. locking 105 data off-chain sent by a data owner into a hardware secure enclave (HSE) by sending encrypted data utilizing Hypertext Transfer Protocol Secure (HTTPS) to said HSE, or enabling said HSE to securely and privately retrieve owner data from a third-party application programming interface (API) off-chain by making an HTTPS request to said third-party API;
c. providing 110 said smart contract with a unique enclave signature enabling notifications based on said unique enclave signature to be accepted;
d. providing 120 said data owner with a signed blockchain account;
e. storing 130 said data off-chain in said HSE;
f. calling 140 a triggering function off-chain, by a data accessor, from said HSE; said triggering function including a signed blockchain account representing the party accessing said data;
g. notifying 150, by said triggering function, said smart contract on-chain when a data access request is received;
h. submitting 160, by said HSE, a universal attestation request to a processor manufacturer attestation module; said universal attestation request comprising the same HSE code attested for all data access requests;
i. receiving 170, by said smart contract, on-chain verification that said HSE is to be accessed by said blockchain account holder and said smart contract charges for access by transferring tokens from said accessing account to said data owner;
j. notifying 180, by a blockchain relayer, said HSE on receipt of payment;
k. verifying 190, by an HSE application, said transaction by means of a light client or state proofs; and
l. providing 200 requested data or cryptographic proof of properties of said data to said data accessor.

Reference is now made to the above-mentioned method further comprising steps of sealing the data by encrypting the data using the enclave key and storing the encrypting data in the file system, such that only the enclave, or an enclave with the key can decrypt the sealed data.

Reference is now made to the above-mentioned method further comprising steps to ensure that data will not be lost in the case of a failed SGX CPU by configuring the system to enable transfer of the enclave key between a group of HW enclaves, such that if one CPU fails, the other CPUs can recover the data and enable continued operation of the service. The system is further configured such that the enclave key cannot be extracted from the enclaves.

Reference is now made to the abovementioned method wherein the blockchain may be a forkable blockchain.

Reference is now made to the abovementioned method wherein the system includes a plurality of relayers.

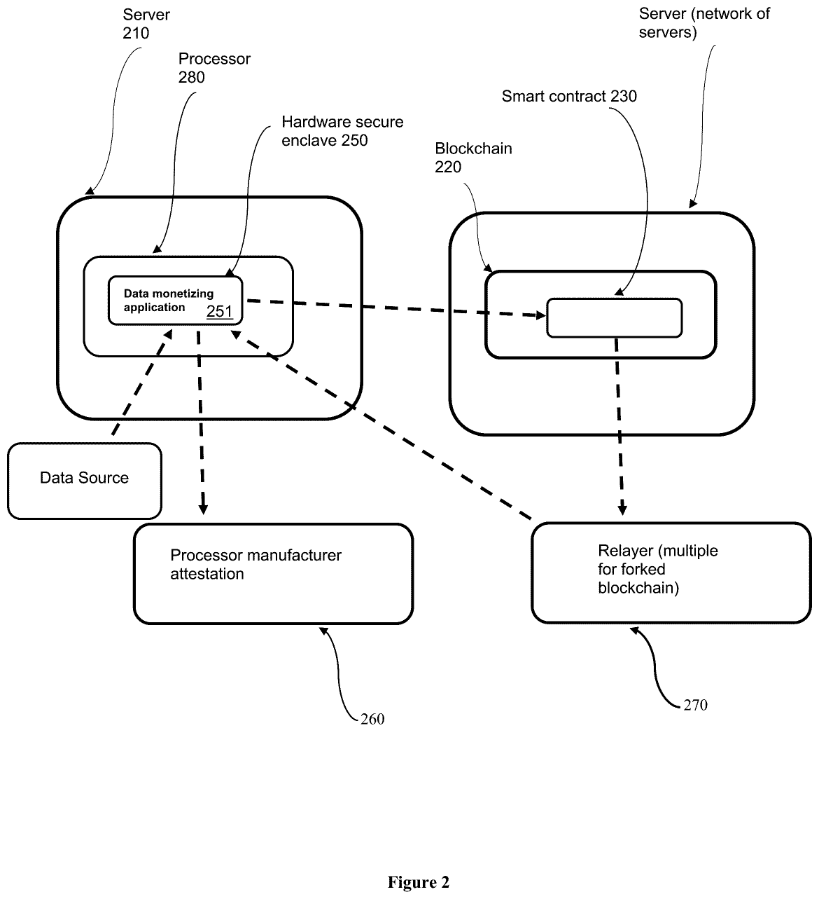

Reference is now made to FIG. 2 disclosing an embodiment of the present invention, which provides a server-based 210 blockchained system for monetizing access to data. The system comprises:
a. at least one computer-readable memory;
b. at least one computer-readable medium (CRM);
c. at least one processor 280;
d. a hardware secure enclave (HSE) 250 implemented within the at least one processor 280; the HSE 250 configured to provide a signed blockchain account for receipt of payment for a data storage module within the HSE 250;
e. a data monetizing application implemented within the HSE 250;
f. an enclave API for rendering the data or cryptographic proof of properties of the data, inaccessible except through the enclave API having a function for retrieving the data or cryptographic proof of properties of the data; and
g. machine-readable instructions stored on the at least one CRM for execution by the at least one processor 280 via the at least one memory, configured to:
   i. submit funds on-chain into a smart contract 230 with stated intent to access specific data via an on-chain data policy;
   ii. lock data off-chain sent by a data owner into the HSE 250 by sending encrypted data utilizing Hypertext Transfer Protocol Secure (HTTPS) to the HSE 250, or enable the HSE 250 to securely and privately retrieve owner data from a third-party application programming interface (API) off-chain by making an HTTPS request to the third-party API;
   iii. provide the smart contract 230 with a unique enclave signature enabling notifications based on the unique enclave signature to be accepted;
   iv. provide the data owner with a signed blockchain account;
   v. store the data off-chain in the HSE 250;
   vi. call a triggering function off-chain, by a data accessor, from the HSE 250; the triggering function including a signed blockchain account representing the party accessing the data;
   vii. notify, by the triggering function, the smart contract on-chain when a data access request is received;
   viii. submit, by the HSE 250, a universal attestation request to a processor manufacturer attestation module 260; the universal attestation request comprising the same HSE 250 code attested for all data access requests;
   ix. receive, by the smart contract 230, on-chain verification that the HSE 250 is to be accessed by the blockchain account holder and the smart contract 230 charges for access by transferring tokens from the data accessor to the data owner; the payment may be taken in one step, escrowed by the smart contract 230;
   x. notify, by a blockchain relayer 270, the HSE 250 on receipt of payment;
   xi. verify, by the data monetizing application 251, the transaction by means of a light client or state proofs; and
   xii. provide requested data or cryptographic proof of properties of the data to the data accessor.

Reference is now made to the aforementioned system wherein the enclave application is programmed to verify the fee payment transfer transaction using a light client, state proofs, before sending requested data to the data accessor.

1. A server-based blockchained system for monetizing access to data, comprising:
a. at least one computer-readable memory;
b. at least one computer-readable medium (CRM);
c. at least one processor;
d. a hardware secure enclave (HSE) implemented within said at least one processor; said HSE configured to provide a signed blockchain account for receipt of payment for a data storage module within said HSE;
e. a data monetizing application implemented within said HSE;
f. an enclave API for rendering said data or cryptographic proof of properties of said data, inaccessible except through said enclave API having a function for retrieving said data or cryptographic proof of properties of the data; and
g. machine-readable instructions stored on said at least one CRM for execution by said at least one processor via said at least one memory, configured to:
i. submit funds on-chain into a smart contract with stated intent to access specific data via an on-chain data policy;
ii. lock data off-chain sent by a data owner into said HSE by sending encrypted data utilizing Hypertext Transfer Protocol Secure (HTTPS) to said HSE, or enable said HSE to securely and privately retrieve owner data from a third-party application programming interface (API) off-chain by making an HTTPS request to said third-party API;
iii. provide said smart contract with a unique enclave signature enabling notifications based on said unique enclave signature to be accepted;
iv. provide said data owner with a signed blockchain account;
v. store said data off-chain in said HSE;
vi. call a triggering function off-chain, by a data accessor, from said HSE; said triggering function including a signed blockchain account representing the party accessing said data;
vii. notify, by said triggering function, said smart contract on-chain when a data access request is received;
viii. submit, by said HSE, a universal attestation request to a processor manufacturer attestation module; said universal attestation request comprising the same HSE code attested for all data access requests;
ix. receive, by said smart contract, on-chain verification that said HSE is to be accessed by said blockchain account holder and said smart contract charges for access by transferring tokens from said data accessor to said data owner; said payment may be taken in one step, escrowed by said smart contract;
x. notify, by a blockchain relayer, said HSE on receipt of payment;
xi. verify, by said data monetizing application, said transaction by means of a light client or state proofs; and
xii provide requested data or cryptographic proof of properties of said data to said data accessor.

2. The system of claim 1, wherein said system comprises a blockchain relayer module for notifying said HSE that payment of said charge was made.

3. The system of claim 1, wherein said enclave application is programmed to verify the fee payment transfer transaction using a light client, state proofs, before enabling requested data (or cryptographic proof of properties of the data), to be retrieved by said data accessor.

4. A method of locking and monetizing access to data by steps of:
a. submitting funds on-chain into a smart contract with stated intent to access specific data via an on-chain data policy;
b. locking data off-chain sent by a data owner into a hardware secure enclave (HSE) by sending encrypted data utilizing Hypertext Transfer Protocol Secure (HTTPS) to said HSE, or enabling said HSE to securely and privately retrieve owner data from a third-party application programming interface (API) off-chain by making an HTTPS request to said third-party API;
c. providing said smart contract with a unique enclave signature enabling notifications based on said unique enclave signature to be accepted;
d. providing said data owner with a signed blockchain account;
e. storing said data off-chain in said HSE;
f. calling a triggering function off-chain, by a data accessor, from said HSE; said triggering function including a signed blockchain account representing the party accessing said data;
g. notifying, by said triggering function, said smart contract on-chain when a data access request is received;
h. submitting, by said HSE, a universal attestation request to a processor manufacturer attestation module; said universal attestation request comprising the same HSE code attested for all data access requests;
i. receiving, by said smart contract, on-chain verification that said HSE is to be accessed by said blockchain account holder and said smart contract charges for access by transferring tokens from said accessing account to said data owner;
j. notifying, by a blockchain relayer, said HSE on receipt of payment;
k. verifying, by an HSE application, said transaction by means of a light client or state proofs; and
l. providing requested data or cryptographic proof of properties of said data to said data accessor.

5. The method of claim 4, comprising further steps of sealing said data by encrypting said data using said enclave key and storing said encrypted data in a file system, such that only said HSE, or an enclave with said key can decrypt said sealed data.

6. The method of claim 4, comprising further steps of said data owner digitally signing and enabling a secure and encrypted HTTPS call directly from said HSE to a third-party service to retrieve said data on behalf of said data owner.

7. The method of claim 5, comprising further steps to ensure said data will not be lost in case of a failed Software Guard Extensions (SGX) central processing unit (CPU), said method enabling transfer of said enclave key between a group of HSEs, such that if one CPU fails, the other CPUs can recover said data and enable continued operation of said system configured such that said enclave key cannot be extracted from said HSEs.

8. The method of claim 4, wherein said blockchain is a forked blockchain.

9. The method of claim 4, wherein there are a plurality of blockchain relayers.
